(19) United States
(12) Patent Application Publication
(10) Pub. No.: US 2005/0240724 A1
(43) Pub. Date: Oct. 27, 2005

(54) Disk array device and cache control method for disk array device

(76) Inventors: Hiroshi Koizumi, Odawara (JP); Shoko Umemura, Tokyo (JP)

Correspondence Address: REED SMITH LLP, Suite 1400, 3110 Fairview Park Drive, Falls Church, VA, 22042, US

(21) Appl. No.: 10/866,676

(22) Filed: Jun. 15, 2004

(30) Foreign Application Priority Data
Apr. 21, 2004 (JP) 2004-125573

(51) Int. Cl. G06F 12/00

(52) U.S. Cl. 711/113; 711/114

(57) ABSTRACT

There are provided a disk array device in which the residing of the data in the cache memory is flexibly controlled and thereby effective use of the cache can be achieved in utilizing the resident data in the cache memory, and a cache control method for the disk array device. In the disk array device, based on cache-resident information issued in association with a job processed in a server, a storage control device controls residence or non-residence of data associated with the job in the cache memory.

### CROSS-REFERENCE TO RELATED APPLICATION

The present application claims priority from Japanese patent application No. JP 2004-125573 filed on Apr. 21, 2004, the content of which is hereby incorporated by reference into this application.

### BACKGROUND OF THE INVENTION

The present invention relates to a disk array device and a cache control method for the disk array device and particularly to a technique effectively applied to a cache control for making specific data resident in a cache.

In a conventional disk array device, a cache memory for temporarily storing data transferred between an upper device such as a server or host computer and a disk drive is used to make faster an access processing of a disk into the disk drive. Also, as a cache control technique in the disk array device, a function of making specific data resident in a cache memory (hereinafter abbreviated as “cache-resident function”) has been used to make, for example, frequently-accessed data etc. resident in the cache memory and further to make faster the access processing of the disk into the disk drive.

Still further, as an example of a technique for making the data resident in the cache memory, Japanese Patent Laid-Open No. 8-328961 discloses a cache-control system for controlling a resident bit corresponding to the data stored in the cache memory by a mode of a resident-bit controller, whereby the system controls residence of the data stored in the cache memory.

### SUMMARY OF THE INVENTION

As for the cache control technique in the conventional disk array device, when data is made resident in the cache memory by using the cache-resident function, the cache-resident function becomes in an ON state. Therefore, once the data resides, the data resides permanently and the flexible control cannot be performed. Moreover, the residing of the data in the cache can be changed by an administrator etc. manually operating a management terminal etc. connected to the disk array device. However, the cache residence cannot be controlled automatically based on a job etc. executed in the upper device such as a server or host computer connected to the disk array device.

Further, in the conventional technique disclosed in Japanese Patent Laid-Open No. 8-328961, the residing of the data in the cache memory is controlled by controlling the resident bit with the mode of the resident-bit controller. However, the mode of the resident-bit controller is set when an administrator etc. of an information processing device executes a program. In this case, the residing of the data is controlled manually by an operation of the administrator, but the mode cannot be automatically set based on the job etc. executed in the information processing device.

Therefore, an object of the present invention is to provide a disk array device in which the residing of the data in the cache memory is flexibly controlled and thereby effective use of the cache can be achieved in making the data resident in the cache memory and utilizing it, and to provide a cache control method for the disk array device

The above and other objects and novel features of the present invention will become apparent from the description of this specification and the accompanying drawings.

Outlines of representative ones of inventions disclosed in the present application will be briefly described as follows.

A disk array device according to the present invention comprises: a storage control device including a channel control unit having connected to an upper device and performing data transfer control, a disk control unit connected to a storage device and performing data transfer control, a cache memory temporarily storing data transferred between the upper device and the storage device, a shared memory storing control information communicated by the channel control unit and the disk control unit, and a connecting unit connected to the channel control unit, the disk control unit, the cache memory, and the shared memory; and a storage drive device configured from a plurality of the storage devices, wherein, based on cache-resident information issued in association with a job processed in the upper device, the storage control device controls residence or non-residence of data associated with the job in the cache memory.

A cache control method for a disk array device according to the present invention comprises: a storage control device including a channel control unit having connected to an upper device and performing data transfer control, a disk control unit connected to a storage device and performing data transfer control, a cache memory temporarily storing data transferred between the upper device and the storage device, a shared memory storing control information communicated by the channel control unit and the disk control unit, and a connecting unit connected to the channel control unit, the disk control unit, the cache memory, and the shared memory; and a storage drive device configured from a plurality of the storage devices, wherein, based on cache-resident information issued in association with a job processed in the upper device, the storage control device controls residence or non-residence of data associated with the job in the cache memory.

### BRIEF DESCRIPTION OF THE DRAWINGS

FIG. 1 is a block diagram showing the entire configuration of a disk array device according to an embodiment of the present invention.

FIG. 2 is an explanatory view for schematically explaining a cache-resident processing in a disk array device according to an embodiment of the present invention.

FIG. 3A is an explanatory view for explaining designing of a dynamic cache-resident processing in a disk array device according to an embodiment of the present invention.

FIG. 3B is an explanatory view for explaining designing of a dynamic cache-resident processing in a disk array device according to an embodiment of the present invention.

FIG. 3C is an explanatory view for explaining designing of a dynamic cache-resident processing in a disk array device according to an embodiment of the present invention.

FIG. 3D is an explanatory view for explaining designing of a dynamic cache-resident processing in a disk array device according to an embodiment of the present invention.

FIG. 4 is an explanatory view for explaining an operation of a dynamic cache-resident processing in a disk array device according to an embodiment of the present invention.

FIG. 5 is an explanatory view for explaining an operation of a dynamic cache-resident processing in a disk array device according to an embodiment of the present invention.

FIG. 6 is an explanatory view for explaining an operation of a dynamic cache-resident processing in a disk array device according to an embodiment of the present invention.

FIG. 7 is an explanatory view for explaining an operation of a dynamic cache-resident processing in a disk array device according to an embodiment of the present invention.

FIG. 8 is an explanatory view for explaining an operation of a dynamic cache-resident processing in a disk array device according to an embodiment of the present invention.

FIG. 9 is an explanatory view for explaining an operation of a dynamic cache-resident processing in a disk array device according to an embodiment of the present invention.

FIG. 10 is a flowchart showing an operation of a dynamic cache-resident processing in a disk array device according to an embodiment of the present invention.

FIG. 11 is a view showing an example of a command for cache residence in a disk array device according to an embodiment of the present invention.

FIG. 12 is a view showing an example of a command for cache residence in a disk array device according to an embodiment of the present invention.

FIG. 13 is a view showing an example of a command for cache residence in a disk array device according to an embodiment of the present invention.

FIG. 14 is an explanatory view for explaining an access processing at the time of a read processing in a disk array device according to an embodiment of the present invention.

FIG. 15 is an explanatory view for explaining an access processing at the time of a write processing in a disk array device according to an embodiment of the present invention.

FIG. 16 is an explanatory view for explaining an access processing at the time of a write processing in a disk array device according to an embodiment of the present invention.

### DESCRIPTION OF THE PREFERRED EMBODIMENTS

Hereinafter, an embodiment of the present invention will be detailed based on the drawings. Note that the same members are denoted by the same reference symbol in principle throughout all the drawings for explaining the embodiment and the repetitive description thereof will be omitted.

<Example of Entire Configuration of Disk Array Device>

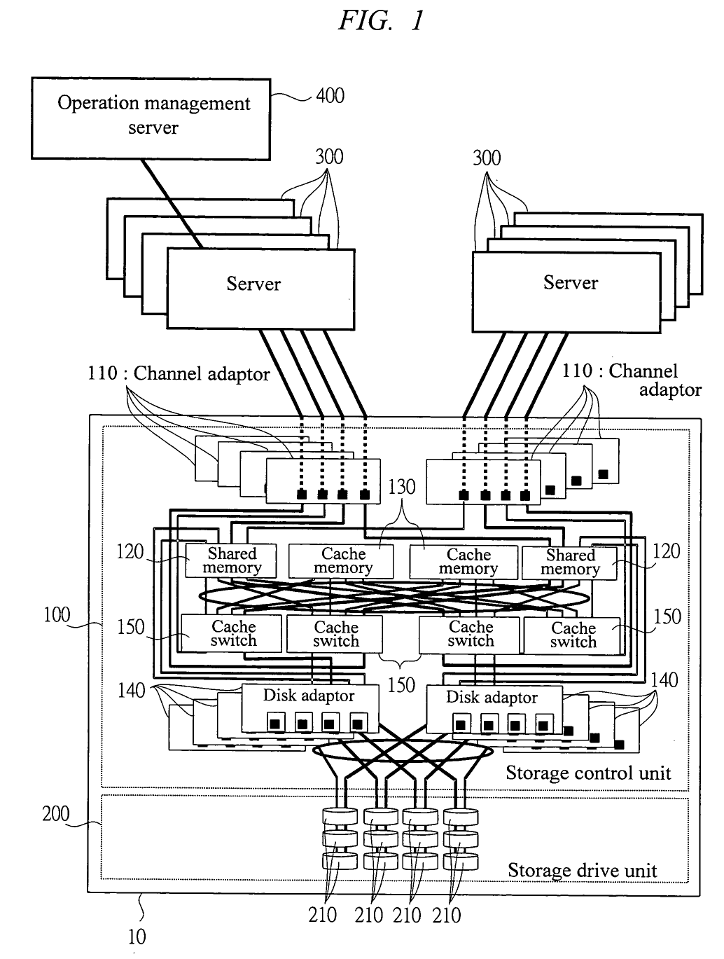

With reference to FIG. 1, an example of the entire configuration of a disk array device according to an embodiment of the present invention will be described. FIG. 1 is a block diagram showing the entire configuration of the disk array device.

In FIG. 1, a disk array device 10 comprises a storage control device 100 and a storage drive device 200.

The storage control device 100 comprises a plurality of channel adaptors (channel control units) 110, a shared memory 120, a cache memory 130, a plurality of disk adaptors (disk control units) 140, and a cache switch (connecting unit) 150.

A server 300 such as an application server functioning as an upper device using the disk array device 10 is connected to the disk array device 10 via the plurality of channel adaptors 110 of the storage control device 100. An operation management sever 400, by which an end user of the disk array device 10 manages a job etc. to be coped with in a server 300, is connected to the server 300.

Control software (e.g., Raid Manager), which operates and sets the configurations of the disks in the disk array device 10 and controls the operation of the disk array device 10, is installed in the server 300. This control software on the server 300 issues a command etc. to the disk array device 10, thereby allowing the operation of the disk array device 10 to be controlled.

The operation management server 400 manages application tasks by jobs executed on the server 300. For example, with the use of operation management software etc., start and end of the jobs and a sequence of the jobs, etc. are managed.

The storage drive device 200 includes a large number of physical disk drives (storage devices) 210. This makes it possible to provide a large-capacity storage area to the server 300. The physical disk drive 210 can be configured by a data storage medium such as a hard disk drive or by a plurality of hard disk drives configuring a RAID (Redundant Array of Inexpensive Disks).

The storage control device 100 establishes communication with the server 300 via the channel adaptors 110. For example, control is got over the storage drive device 200 in accordance with a command received from the server 300. By way of example, by receiving a data input/output request from the server 300, data stored in the physical disk drives 210 included in the storage driving device 200 is read/written.

The cache switch 150 connects the channel adaptors 110, the shared memory 120, the cache memory 130, and the disk adaptors 140 to one another.

The shared memory 120 and the cache memory 130 are storage memories shared by the channel adaptors 110 and the disk adaptors 140. The shared memory 120 is used mainly for storing control information, and commands, etc. while the cache memory 130 is used mainly for storing data.

For example, when the data input/output request received by a certain channel adaptor 110 from the server 300 is a write command, the above channel adaptor 110 writes the write command in the shared memory 120 and simultaneously writes, in the cache memory 130, write data received from the server 300. Meanwhile, when the disk adaptors 140 detect that the write command is written in the shared memory 120 while monitoring the shared memory 120, the write data is read from the cache memory 130 in accordance with the above command and is written in the storage drive device 200.

Also, when the data input/output request received by a certain channel adaptor 110 from the server 300 is a read command, whether data to be a read target exists in the cache memory 130 is checked. Here, if the data exists in the cache memory 130, the above channel adaptor 110 transmits the data to the server 300.

Meanwhile, if data to be a read target does not exist in the cache memory 130, the above channel adaptor 110 writes the read command in the shared memory 120 and simultaneously monitors the shared memory 120. The disk adaptor 140, which detects that the read command has been written in the shared memory 120, reads data to be a read target from the storage drive device 200 and writes it in the cache memory 130 and simultaneously writes that effect in the shared memory 120. Then, if detecting that the data to be a read target has been written in the cache memory 130, the above channel adaptor 110 transmits the data to the server 300.

In this way, a data exchange is made between the channel adaptor 110 and the disk adaptor 140 via the cache memory 130. Of the data stored in the physical disk drives 210, data to be read or written by the channel adaptors 110 or the disk adaptors 140 is stored in the cache memory 130.

Each of the disk adaptors 140 is communicably connected to the plurality of physical disk drives 210 storing data, thereby controlling the storage drive device 200. For example, in response to the data input/output request received by the channel adaptor 110 from the server 300, the reading and writing of the data with respect to the physical disk drives 210 are executed.

<Outline of Cache-Resident Processing>

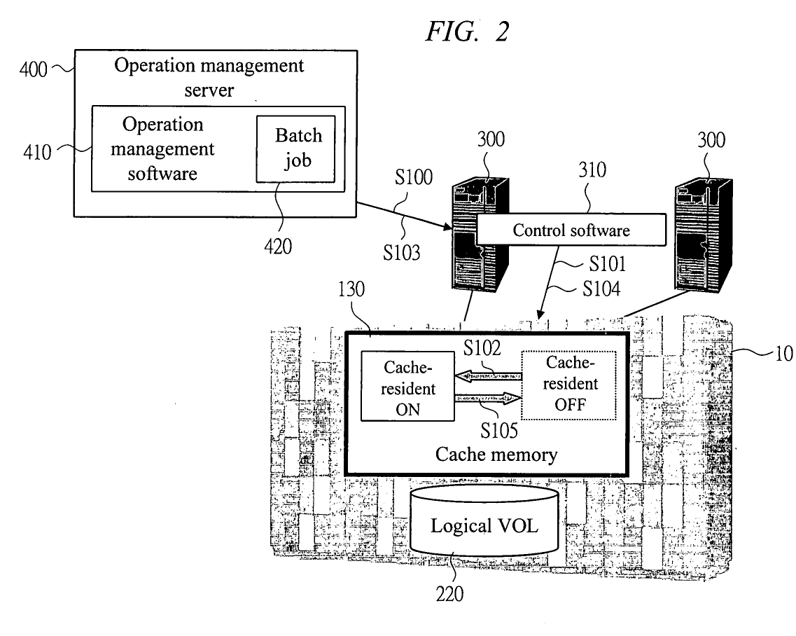

With reference to FIG. 2, an outline of a cache-resident processing of the disk array device according to the embodiment of the present invention will be described. FIG. 2 is an explanatory view for explaining the outline of the cache-resident processing in the disk array device according to the embodiment of the present invention.

In FIG. 2, a logical volume 220 formed by the physical disk drives 210 is created in the disk array device 10. By a data input/output request from the server 300 to the logical volume 220, data on the logical volume 220 is accessed. Furthermore, the cache memory 130 is provided thereon with a resident cache area for making data resident therein. By a command-level instruction from the control software 310 etc. of the server 300 with respect to the resident data in the resident cache area, cache-resident ON or cache-resident OFF is ordered. Still further, in the operation management server 400, a managed batch job 420 is started by operation management software 410 and an instruction of the batch job 420 and an instruction to reside therein in conjunction with it are transferred to the server 300.

First, in the operation management server 400, the operation management software 410 manages the starting sequence etc. of the jobs. If a certain job is started, the operation management software 410 gives, to the control software 310 of the server 300, an instruction to release a cache ON command indicative of cache-resident information in response to starting of the above job (S100).

Next, by the instruction from the operation management server 400, the control software 310 of the server 300 issues the cache ON command for cache residence to the disk array device 10 (S101). The cache residence of the specific data relating to the job based on the information of the cache ON command becomes in an ON state (step S102).

In this state, the specific data associated with the job that has been started by the operation management server 400 is resident in the cache memory 130. Therefore, a cache-hit ratio while the server 300 is executing the job is improved, whereby it is possible to make faster the disk access from the server 300.

Next, when the job currently being executed is over, the operation management software 410 gives, to the control software 310 of the server 300, an instruction to release a cache OFF command indicative of cache-nonresident information (S103).

Next, in respond to the instruction from the operation management server 400, the control software 310 of the server 300 issues the cache OFF command for cache non-residence to the disk array device 10 (S104). The cache residence of the specific data associated with the job based on the information of the cache OFF command becomes in an OFF state (step S105).

Due to such a processing, by starting/ending the batch job 420 managed by the operation management software 410 of the operation management server 400, the cache-resident command and the cache-nonresident command with respect to the specific data associated with the batch job are issued to the disk array device 10 from the control software 310 of the server 300. Therefore, it is possible to flexibly control the data that is made resident in the cache memory 130.

Thus, the specific job can be derived at a cache level in a specific time zone. For this reason, a plurality of applications can be derived at the cache level in the specific time zone. Therefore, it is possible to provide sensitively a variety of services and further to achieve the improvements of the performance of the entire system and the operation performance accordingly.

<Designing of Dynamic Cache-Resident Processing>

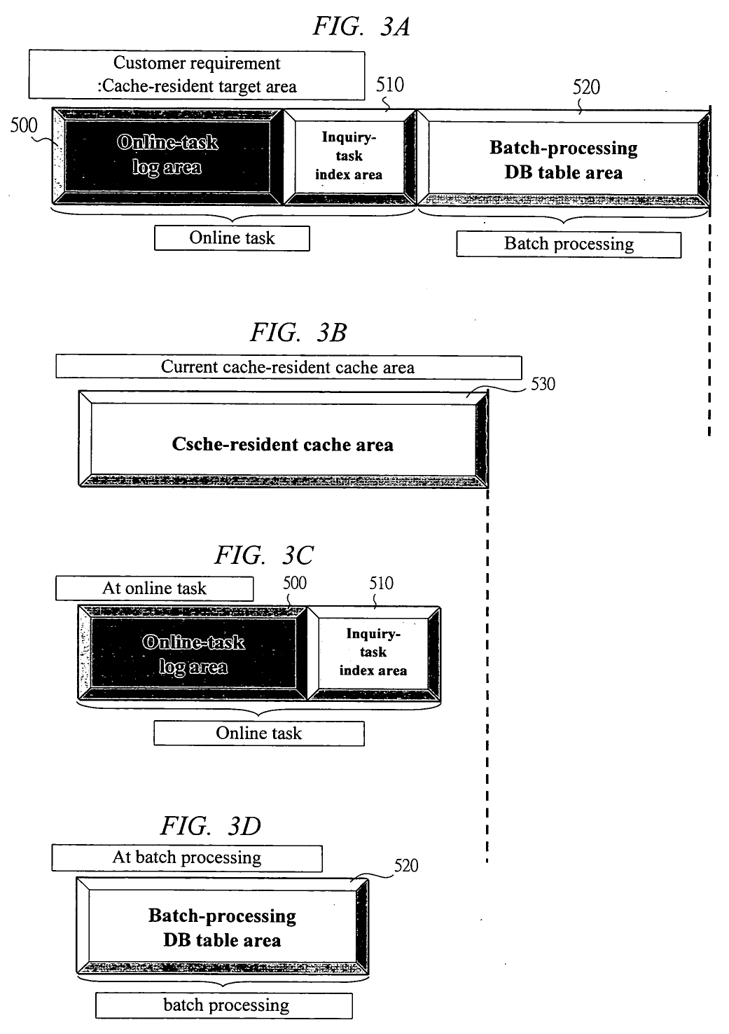

With reference to FIGS. 3A to 3D, designing of a dynamic cache-resident processing of the disk array device according to the embodiment of the present invention will be described. FIGS. 3A to 3D are explanatory views for explaining the designing of the dynamic cache-resident processing of the disk array device according to the embodiment of the present invention.

FIG. 3A shows an area to be a cache-resident target as such a customer requirement that, for example, a customer using the disk array device 10 wishes to make faster the disk accesses during the performing of online tasks in a service time zone or to make faster the disk accesses to the overnight batch processing or the like. In FIG. 3A, a inquiry-task index area 510 to a database and an online-task log area 500 become resident targets as online tasks, and a batch-processing DB table area 520 becomes a resident target as an overnight batch processing.

FIG. 3B shows a cache-resident cache area 530 capable of being allocated as a cache-resident cache area in the cache memory 130; FIG. 3C shows a cache-resident area only at the time of the online task; and FIG. 3D shows a cache-resident area only at the time of the overnight batch processing.

As shown in FIG. 3A, as for the customer requirements, it is desired to make, resident in the cache, the date for the online task and the data for the batch processing for purpose of making faster the disk accesses in the online task and the overnight batch processing. However, if the cache-resident cache area 530 capable of being retained in the cache memory 130 is small as shown FIG. 3B, all the pieces of data as shown in FIG. 3A cannot be made resident in the cache memory 130.

Therefore, by dynamically controlling the residing in the cache memory 130 through the processing as shown in FIG. 2, for example, it is possible to make, resident in the cache memory 130, only the online-task data at the time of the online task as shown in FIG. 3C. Then, by making, resident in the cache memory 130, only the data for the overnight batch processing at the time of the overnight batch processing as shown in FIG. 3D, it is possible to make, resident in the cache-resident cache area 530 as shown in FIG. 3B, all the pieces of data that the cache residence requires at the time of the online task or overnight batch processing.

Thus, by dynamically controlling the cache residence, the cache memory 130 can be efficiently used without waste.

<Dynamic Cache-Resident Processing>

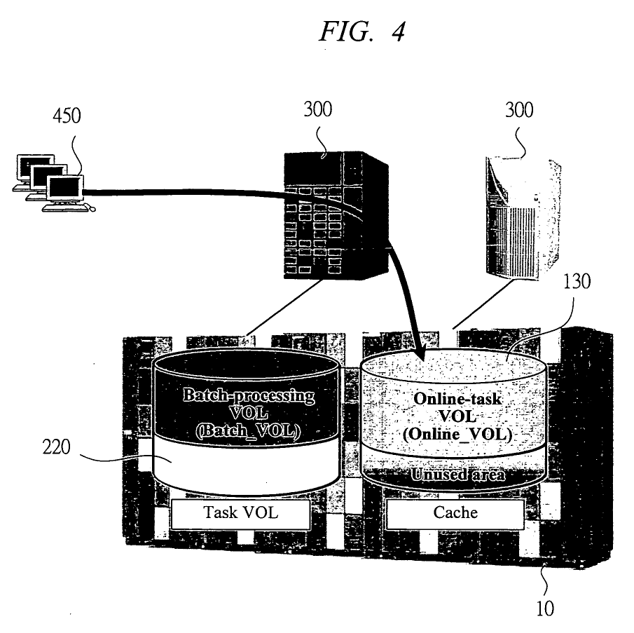

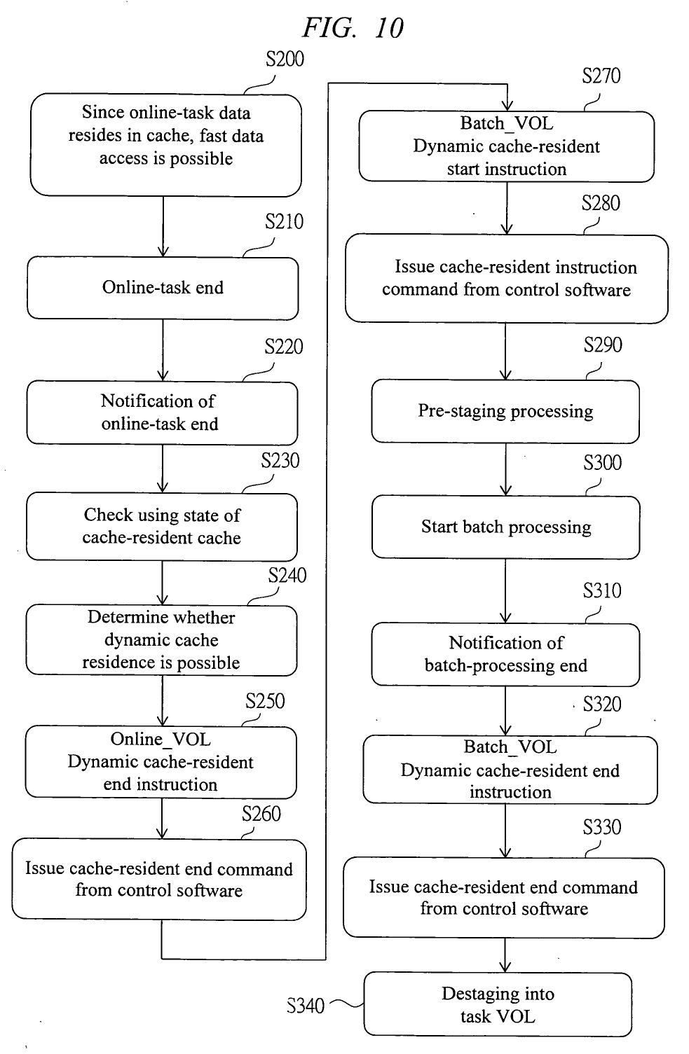

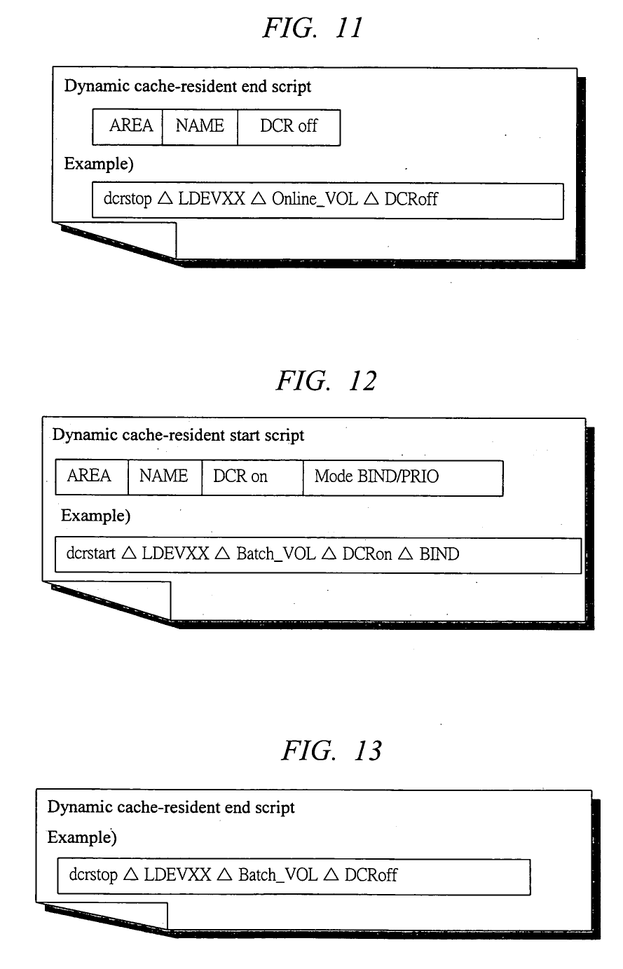

With reference to FIGS. 4 to 13, operations of the dynamic cache-resident processing of the disk array device according to the embodiment of the present invention is will be described. FIGS. 4 to 9 are explanatory views for explaining the operations of the dynamic cache-resident processing of the disk array device according to the embodiment of the present invention; FIG. 10 is a flowchart showing the operation of the dynamic cache-resident processing of the disk array device according to the embodiment of the present invention; and FIGS. 11 to 13 are views showing examples of a command for the cache residence of the disk array device according to the embodiment of the present invention.

First, as shown in FIG. 4, it is assumed that the online-task data (e.g., data of an online-task volume) is resident in the cache memory 130. At this time, since the online-task data resides in the cache memory 130, for example, it is possible to make faster the disk accesses to the disk array device 10 by operating a terminal 450 of the end user connected to the server 300 for using the application etc. on the server 300 (S200 in FIG. 10).

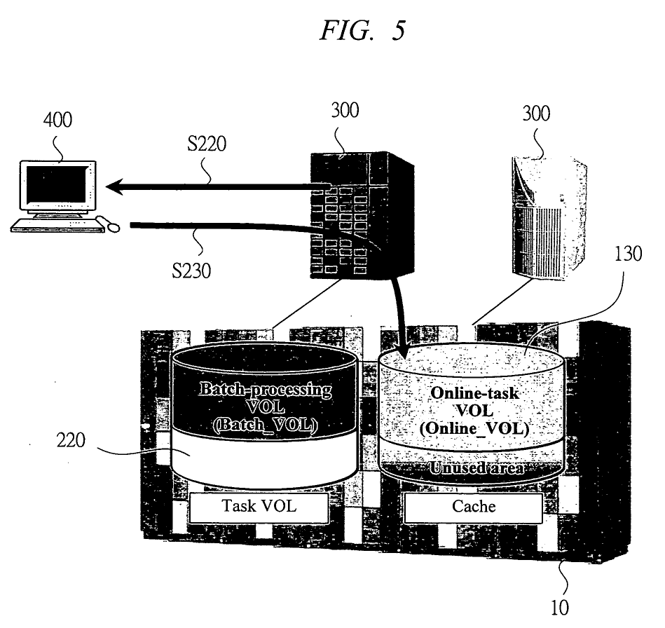

Then, when the online task under the state shown in FIG. 4 ends (S210 in FIG. 10), as shown in FIG. 5, a notification indicative of the online-task end is transmitted from the server 300 to the operation management server 400, whereby an automatic operation of the dynamic cache residence is started (S220 in FIG. 10). The operation management server 400 then checks a state of using the cache memory 130 for the cache residence (S230 in FIG. 10) and determines whether the dynamic cache residence is possible or impossible (S240 in FIG. 10). Here, in S240 in FIG. 10, since the data of the online-task volume as shown in FIG. 5 resides in the cache memory 130, an unused area therein is small. Therefore, since there is no area in which next data of the batch-processing volume resides, it is determined that there is lack of area.

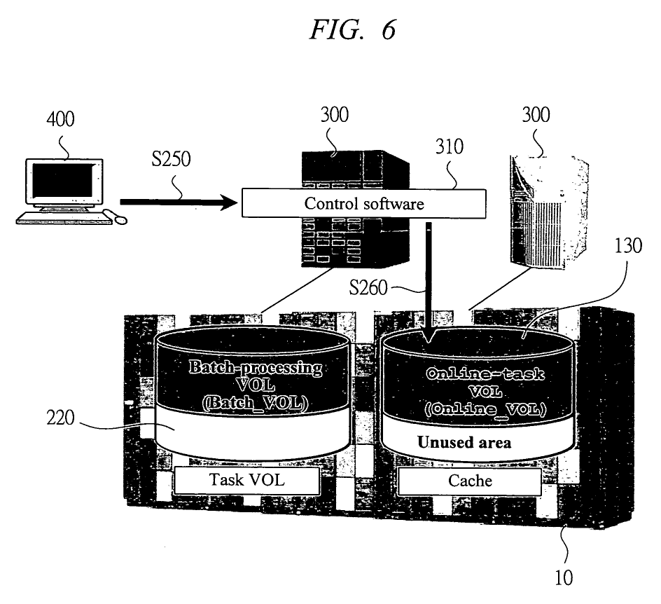

If it is determined in S240 in FIG. 10 that there is lack of area, as shown in FIG. 6, a dynamic cache-resident end instruction to end the fact that the data of the online-task volume resides in the cache is given from the operation management server 400 to the server 300 (S250 in FIG. 10). Then, from the control software 310 of the server 300 to the disk array device 10, for example, a cache-resident end command (e.g., “dcrstop” command) as shown in FIG. 11 is issued (S260 in FIG. 10).

This cache-resident end command is created, for example, as a dynamic cache-resident end script as shown in FIG. 11, wherein the script includes an area for specifying the location of the data (“AREA”), a name for identifying the volume (“NAME”), and information of “DCRoff”. For example, the command is in a script of “dcrstop LDEVXX online_VOL DCRoff”.

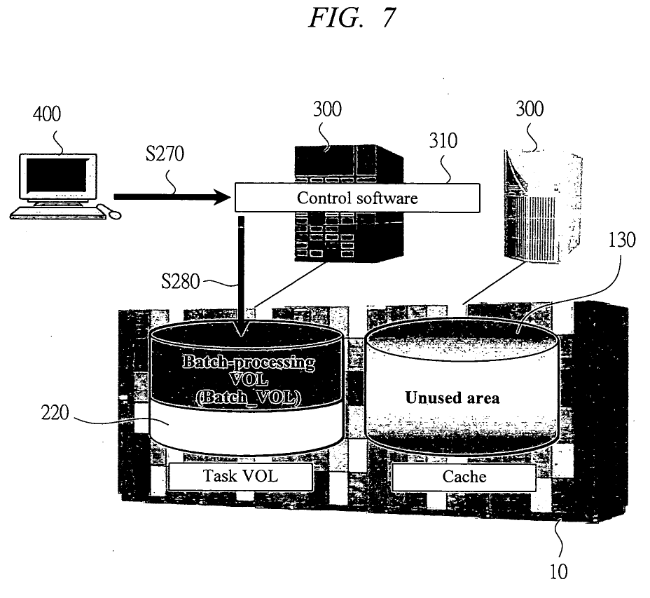

By issuing the cache-resident end command in S260 in FIG. 10, the data having resided in the cache memory 130 as shown in FIG. 7 becomes nonresident and, therefore, the entire cache memory 130 becomes an unused area. Then, from the operation management server 400 to the server 300, a dynamic cache-resident start instruction to start making, resident in the cache, the data of the batch-processing volume is given (S270 in FIG. 10). Then, from the control software 310 of the server 300 to the disk array device 10, for example, a cache-resident instruction command as shown in FIG. 12 (e.g., a “dcrstart” command) is issued (S280 in FIG. 10).

This cache-resident instruction command is created, as shown in FIG. 12, as a dynamic cache-resident start script including an area for specifying the location of the data (“AREA”), a name for identifying the volume (“NAME”), “DCRon”, and information indicative of a mode at the time of cache write. For example, the command is in a script of “dcrstop LDEVXX Batch_VOL DCRon BIND”.

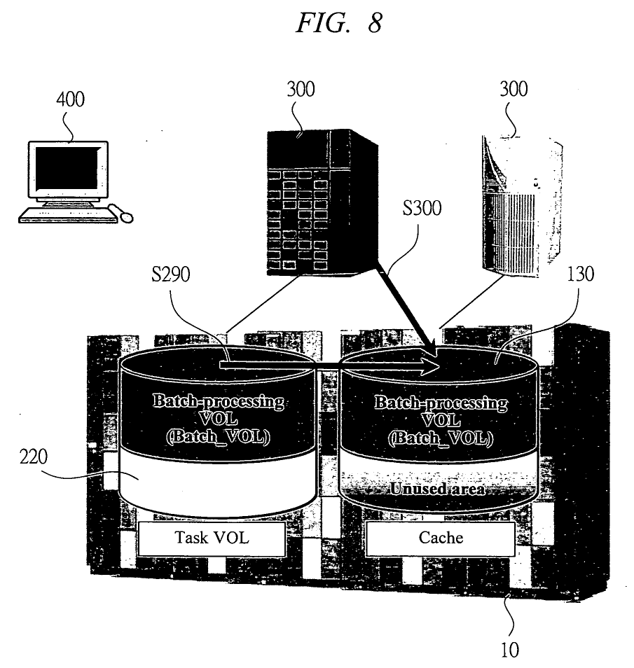

By issuing the cache-resident instruction command in S280 in FIG. 10, as shown in FIG. 8, a pre-staging processing for making, resident in the cache memory 130, the data of the batch-processing volume in a task volume on the logical volume 220 is performed (S290 in FIG. 10). By using the data residing in the cache memory 130, the batch processing is then started (S300 in FIG. 10).

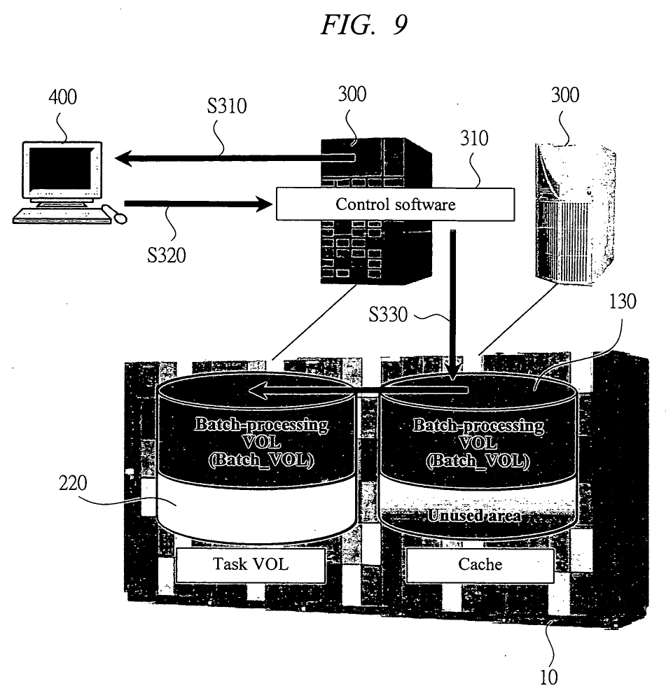

Next, when the batch processing started in S300 in FIG. 10 ends, as shown in FIG. 9, a notification indicative of the batch-processing end is transmitted from the server 300 to the operation management server 400, whereby the automatic operation of the dynamic cache residence is stopped (S310 of FIG. 10). Then, from the operation management sever 400 to the server 300, a dynamic cache-resident end instruction to end the fact that the data of the batch-processing volume resides in the cache is given (S320 in FIG. 10). From the control software 310 of the server 300 to the disk array device 10, for example, a cache-resident end command as shown in FIG. 13 (e.g., “dcrstop” command) is issued (S330 in FIG. 10).

This cache-resident end command is, as shown in FIG. 13, a command on a script of “dcrstop LDEVXX Batch_VOL DCRoff”, for example.

Then, by issuing the cache-resident end command in S330 in FIG. 10, as shown in FIG. 9, the data having resided in the cache memory 130 is destaged into the task volume on the logical volume 220 (S340 in FIG. 10), whereby the processing ends.

Thereafter, in the cache memory 130, the entire cache-resident area becomes an unused area. Then, by a command-level instruction from the operation management server 400 and the server 300, to make the specific data resident in the cache is again controlled.

For the above-described processing, by the command-level instruction from the control software of the server 300 based on start or end of the batch job (e.g., online task or batch processing) managed by the operation management server 400, to make, resident in the cache, the specific data on the cache memory 130 is controlled. Therefore, the make the data resident in the cache memory 130 can be flexibly controlled. Also, the specific data associated with the batch job executed in the server 300 is made resident in the cache memory 130 in each case, so that this makes it possible to effectively use the cache memory 130.

Furthermore, the cache residence on the cache memory 130 can be controlled by the command-level instruction from the control software 310 of the server 300. Therefore, the instructions of the cache residence and/or the cache non-residence can be provided through the same processing as that using the command from the server 300 to the disk array device 10.

<Access Processing to Cache-Resident Data from Server and End User>

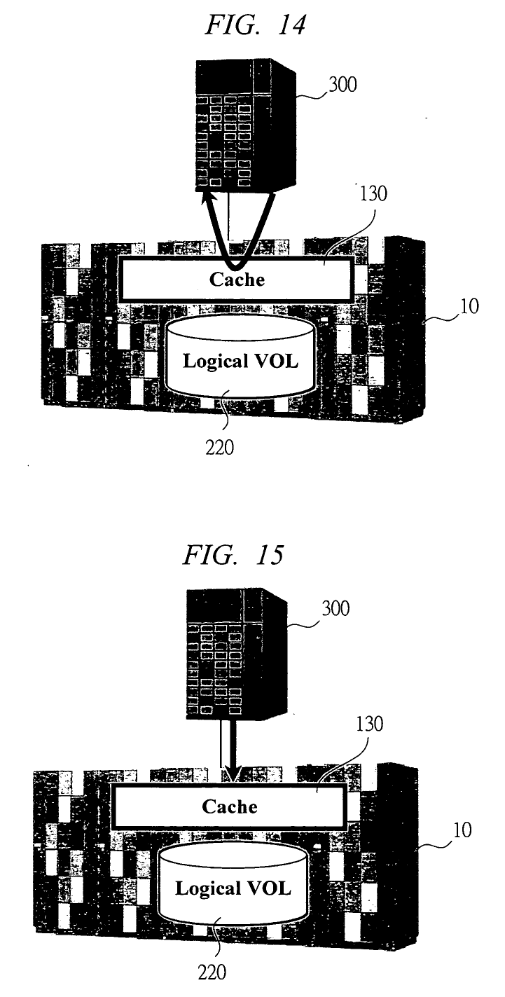

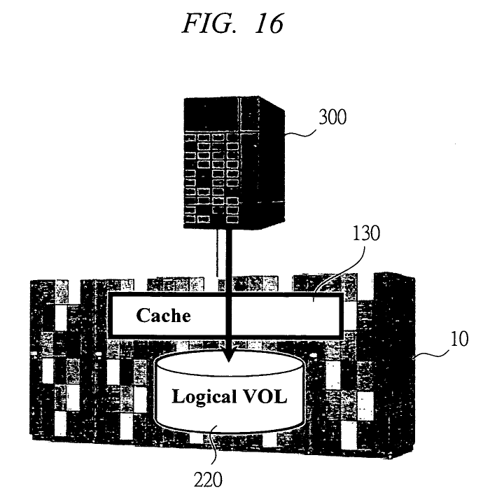

With reference to FIGS. 14 to 16, an access processing to cache-resident data from the server and the end user in the disk array device according to the embodiment of the present invention will be described. FIG. 14 is an explanatory view for explaining an access processing at the time of a read processing in the disk array device according to the embodiment of the present invention; and FIGS. 15 and 16 are explanatory views for explaining an access processing at the time of a write processing in the disk array device according to the embodiment of the present invention.

In the present embodiment, for example, information on a mode at the time of cache write is ordered in the cache-resident instruction command as shown in FIG. 12. For example, when the information on the mode at the time of cache write is “BIND”, as shown in FIG. 15, a write processing into the resident data is performed only in the cache memory 130 and is such a mode that all accesses including a first access are cache hits.

Also, for example, when the information on the mode at the time of cache write is “PRIO”, as shown in FIG. 16, the write processing into the resident data is performed directly to the logical volume 220 and so is such a mode as to be immediately reflected in the logical volume 220.

Furthermore, as for a read processing to the resident data, as shown in FIG. 14, the read processing to the data residing in the cache memory 130 is such that all accesses including a first access are cache hits regardless of a mode.

In each mode as shown in FIGS. 15 and 16, when the specific data resides in the cache memory 130, a side of the operation management server 400 manages in advance a matter as to whether the faster access should be executed or whether the important data should be directly written into the logical volume 220 or the like in accordance with types of the data. Then, the information on the mode is reflected in the command issued from the server 300.

As described in the foregoing, in the present invention, the cache residence on the cache memory 130 can be controlled by the command-level instruction from the control software 310 of the server 300. Therefore, without controlling the cache residence by the operation of the administrator of the disk array device 10 through a control terminal etc., the processing at the command level can be performed under the management of the batch jobs in the operation management server 400. Thus, a variety of services can be offered sensitively.

Therefore, for example, in the batch jobs etc. executed during a busy business period or an account-closing period, the fastest disk access is executed due to the cache residence. Or, for example, during the normal online task using a database, the “INDEX” portion of the database is made resident in the cache memory 130 to make faster a search operation. As such, by optimizing the cache residence on the cache memory 130, the performance of each job can be improved.

As described above, the invention made by the present inventors has been concretely described based on the embodiment. However, needless to say, the present invention is not limited to the above-mentioned embodiment and can be variously modified and altered without departing from the gist thereof.

Effects obtained by representative ones of inventions disclosed in the present application will be briefly described as follows.

According to the present invention, the cache residence is controlled by the command level from the upper device connected to the disk array device. Therefore, the data resident in the cache memory of the disk array device can be flexibly controlled.

1. A disk array device comprising:
a storage control device including a channel control unit connected to an upper device and performing data transfer control, a disk control unit connected to a storage device and performing data transfer control, a cache memory temporarily storing data transferred between said upper device and said storage device, a shared memory storing control information communicated by said channel control unit and said disk control unit, and a connecting unit connected to said channel control unit, said disk control unit, said cache memory, and said shared memory; and
a storage drive device configured by a plurality of said storage devices,
wherein, based on cache-resident information issued in association with a job to be processed in said upper device, said storage control device controls residence of data associated with executing said job in said cache memory when executing said job and controls non-residence of said data in said cache memory when finishing said job.

2. The disk array device according to claim 1,
wherein said cache-resident information is issued from control software for controlling an operation of said disk array device on a side of said upper device.

3. The disk array device according to claim 2,
wherein said cache-resident information is command-level information issued from said control software to said disk array device.

4. The disk array device according to claim 3,
wherein said command-level information is information on a script including a command indicative of cache residence or cache non-residence, information indicative of a location of data to be subjected to the cache residence or cache non-residence, and information indicative of a name of the data to be subjected to the cache residence or cache non-residence.

5. The disk array device according to claim 1,
wherein said cache-resident information is information issued from said upper device based on a cache-resident instruction given to said upper device from an operation management server, which manages start and end of a job executed in said upper device, and given in association with the start and end of said job.

6. A cache control method for a disk array device including a storage control device including a channel control unit connected to an upper device and performing data transfer control, a disk control unit connected to a storage device and performing data transfer control, a cache memory temporarily storing data transferred between said upper device and said storage device, a shared memory storing control information communicated by said channel control unit and said disk control unit, and a connecting unit connected to said channel control unit, said disk control unit, said cache memory, and said shared memory; and
a storage drive device configured by a plurality of said storage devices, said method comprising:
based on cache-resident information issued in association with a job to be processed in said upper device, by said storage control device controlling residence of data associated with executing said job in said cache memory when executing said job and controlling non-residence of said data in said cache memory when finishing said job.

7. The cache control method for a disk array device according to claim 6,
wherein said cache-resident information is issued from control software for controlling an operation of said disk array device on a side of said upper device.

8. The cache control method for a disk array device according to claim 7,
wherein said cache-resident information is command-level information issued from said control software to said disk array device.

9. The cache control method for a disk array device according to claim 8,
wherein said command-level information is information on a script including a command indicative of cache residence or cache non-residence, information indicative of a location of data to be subjected to the cache residence or cache non-residence, and information indicative of a name of the data to be subjected to the cache residence or cache non-residence.

10. The cache control method for the disk array device according to claim 6,
wherein said cache-resident information is information issued from said upper device based on a cache-resident instruction given to said upper device from an operation management server, which manages start and end of a job executed in said upper device, and given in association with the start and end of said job.
